(19) United States
(12) Patent Application Publication
(10) Pub. No.: US 2026/0289398 A1
(43) Pub. Date: Sep. 24, 2026

(54) METHOD AND SYSTEM FOR COMPRESSION AND DYNAMIC LOSS-BASED TRAINING OF GENERATIVE ARTIFICIAL INTELLIGENCE MODELS

(71) Applicant: L&T TECHNOLOGY SERVICES LIMITED, Chennai (IN)

(72) Inventors: VIKRAM SUBRAMANI, Krishnagiri (IN); SUDHIR BHADAURIA, Ahmedabad (IN)

(21) Appl. No.: 19/220,208

(22) Filed: May 28, 2025

(30) Foreign Application Priority Data
Mar. 20, 2025 (IN) 202541025239

(51) Int. Cl. G06N 20/00

(52) U.S. Cl. CPC G06N 20/00

(57) ABSTRACT

This disclosure relates to method and system for compression and dynamic loss-based training of Generative Artificial Intelligence (GenAI) models. The method may include preparing a compressed GenAI model from a GenAI model based on a user-defined rank. For each training data element, the method may include calculating a set of loss values based on outputs of the compressed GenAI model and the GenAI model, and ground truth output. The method may include dynamically calculating weights of the set of loss values based on one of the set of loss values. The method may include calculating weighted loss value for the compressed GenAI model based on the set of loss values and the weight. The method may include modifying the plurality of compressed weights based on weighted loss value to obtain a fine-tuned compressed GenAI model.

### TECHNICAL FIELD

This disclosure relates generally to Generative Artificial Intelligence (GenAI) models, and more particularly to method and system for compression and dynamic loss-based training of GenAI models.

### BACKGROUND

Generative Artificial Intelligence (GenAI) models (for example, GPT, LLaMA, BERT) may be pre-trained on a vast amount of data to learn general language patterns. A pre-trained GenAI model may lack domain and task specificity. The pre-trained GenAI model may be fine-tuned using a fine-tuning technique to obtain a fine-tuned GenAI model that is domain-specific and task-specific.

In the present state of art, the fine-tuning technique may be a full fine-tuning or a Parameter-Efficient Fine-Tuning (PEFT). The full fine-tuning includes retraining of all parameters of the pre-trained GenAI model based on a task-specific dataset. The full fine-tuning may achieve high task accuracy and adaptability in the fine-tuned GenAI model. However, the full fine-tuning is computationally expensive, requires large task-specific datasets, and may lead to catastrophic forgetting in the fine-tuned GenAI model.

On the other hand, the PEFT includes fine-tuning a subset of parameters of the pre-trained GenAI model while freezing rest of the parameters. Some conventional PEFT techniques include a LoRA (Low-Rank Adaptation) fine-tuning, adapters-based fine-tuning, and prefix-tuning/prompt-tuning. The PEFT may reduce memory and computational requirements during fine-tuning of GenAI model, while maintaining the benefits of the pre-trained GenAI model. However, the PEFT may lead to an increased size of the fine-tuned GenAI model during inference, computation overhead, and inference-specific overhead.

Thus, the present invention is directed to overcome one or more limitations stated above or any other limitations associated with the known arts.

### SUMMARY

In one embodiment, a method for compression and dynamic loss-based training of Generative Artificial Intelligence (GenAI) models is disclosed. In one example, the method may include receiving a GenAI model and a user-defined rank. The GenAI model may include a plurality of weights. The method may further include preparing a compressed GenAI model from the GenAI model based on the user-defined rank. The compressed GenAI model may include a plurality of compressed weights. A number of the plurality of compressed weights is less than a number of the plurality of weights. For each of a plurality of training data elements in an input training dataset, the method may further include calculating a set of loss values based on an output generated through each of the compressed GenAI model and the GenAI model for a training data element, and a ground truth output for the training data element. The method may further include dynamically calculating a weight corresponding to each of the set of loss values based on one of the set of loss values. The method may further include calculating a weighted loss value for the compressed GenAI model corresponding to the training data element based on the set of loss values and the dynamically calculated weight. The method may further include modifying the plurality of compressed weights based on the weighted loss value to obtain a fine-tuned compressed GenAI model.

In one embodiment, a system for compression and dynamic loss-based training of GenAI models is disclosed. In one example, the system may include a processor and a memory communicatively coupled to the processor. The memory may store processor-executable instructions, which, on execution, may cause the processor to receive a GenAI model and a user-defined rank. The GenAI model may include a plurality of weights. The processor-executable instructions, on execution, may further cause the processor to prepare a compressed GenAI model from the GenAI model based on the user-defined rank. The GenAI model may include a plurality of weights. The compressed GenAI model may include a plurality of compressed weights. A number of the plurality of compressed weights is less than a number of the plurality of weights. For each of a plurality of training data elements in an input training dataset, the processor-executable instructions, on execution, may further cause the processor to calculate a set of loss values based on an output generated through each of the compressed GenAI model and the GenAI model for a training data element, and a ground truth output for the training data element. The processor-executable instructions, on execution, may further cause the processor to dynamically calculate a weight corresponding to each of the set of loss values based on one of the set of loss values. The processor-executable instructions, on execution, may further cause the processor to calculate a weighted loss value for the compressed GenAI model corresponding to the training data element based on the set of loss values and the dynamically calculated weight. The processor-executable instructions, on execution, may further cause the processor to modify the plurality of compressed weights based on the weighted loss value to obtain a fine-tuned compressed GenAI model.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for compression and dynamic loss-based training of Generative Artificial Intelligence (GenAI) models, in accordance with some embodiments.

FIG. 2 illustrates a functional block diagram of an exemplary system for compression and dynamic loss-based training of GenAI models, in accordance with some embodiments.

FIG. 3 illustrates a flow chart of an exemplary process for compression and dynamic loss-based training of GenAI models, in accordance with some embodiments.

FIG. 4 illustrates a flow chart of an exemplary process for calculating loss values of compressed GenAI models, in accordance with some embodiments.

FIG. 5 illustrates a flow chart of an exemplary process for dynamically calculating weights corresponding to loss values of compressed GenAI models, in accordance with some embodiments.

FIG. 6 illustrates a flow chart of a detailed exemplary process for compression and dynamic loss-based training of pretrained Large Language Models (LLMs), in accordance with an embodiment.

FIG. 7 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

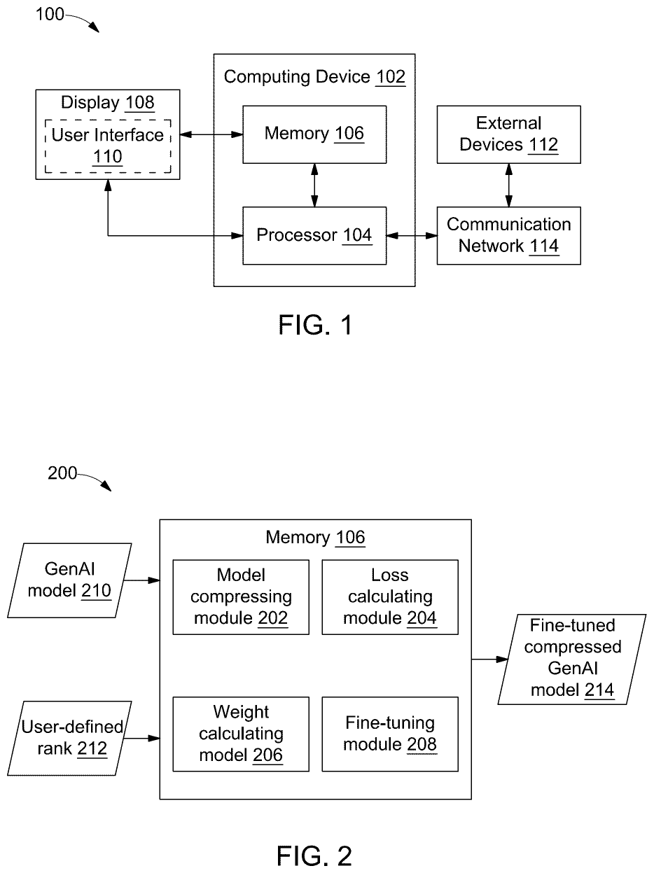

Referring now to FIG. 1, an exemplary system 100 for compression and dynamic loss-based training of Generative Artificial Intelligence (GenAI) models is illustrated, in accordance with some embodiments. The system 100 may include a computing device 102 (for example, a server, a desktop, a laptop, a notebook, a netbook, a tablet, a smartphone, a mobile phone, or any other computing device), in accordance with some embodiments of the present disclosure. The computing device 102 may be configured to perform compression and dynamic loss-based training of a GenAI model. By way of an example, the GenAI model may be a Large Language Model (for example, Generative Pre-trained Transformer (GPT)-3, GPT-3.5, GPT-4, Language Model for Dialogue Applications (LaMDA), Pathways Language Model (PaLM), BigScience Large Open-science Open-access Multilingual Language Model (BLOOM), Large Language Model Meta AI (Llama), Mistral 7B, Mixtral 8×7B, Mixtral 8×22B, etc.) or a multimodal model (for example, DALL-E, Large Language and Vision Assistant (LLaVA), GPT-4o, Gemini, Claude 3, etc.).

As will be described in greater detail in conjunction with FIGS. 2-7, the computing device 102 may receive a GenAI model and a user-defined rank. The GenAI model may include a plurality of weights. The computing device 102 may prepare a compressed GenAI model from the GenAI model based on the user-defined rank. The compressed GenAI model may include a plurality of compressed weights. A number of the plurality of compressed weights is less than a number of the plurality of weights. For each of a plurality of training data elements in an input training dataset, the computing device 102 may calculate a set of loss values based on an output generated through each of the compressed GenAI model and the GenAI model for a training data element, and a ground truth output for the training data element. The computing device 102 may further dynamically calculate a weight corresponding to each of the set of loss values based on one of the set of loss values. The computing device 102 may further calculate a weighted loss value for the compressed GenAI model corresponding to the training data element based on the set of loss values and the dynamically calculated weight. The computing device 102 may modify the plurality of compressed weights based on the weighted loss value to obtain a fine-tuned compressed GenAI model.

In some embodiments, the computing device 102 may include one or more processors 104 and a memory 106. The memory 106 may store instructions that, when executed by the one or more processors 104, may cause the one or more processors 104 to perform compression and dynamic loss-based training of GenAI models, in accordance with aspects of the present disclosure. The memory 106 may also store various data (for example, user-defined rank, plurality of weights, a set of loss values, and the like) that may be captured, processed, and/or required by the computing device 102.

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or any other computing device.

Referring now to FIG. 2, a functional block diagram of an exemplary system 200 for compression and dynamic loss-based training of GenAI models is illustrated, in accordance with some embodiments. FIG. 2 is explained in conjunction with FIG. 1. The system 200 may be analogous to the system 100. The system 200 may include, within the memory 106, a model compressing module 202, a loss calculating module 204, a weight calculating module 206, and a fine-tuning module 208.

The model compressing module 202 may receive a GenAI model 210 and a user-defined rank 212. The GenAI model 210 may include a plurality of weights in each of a plurality of layers of the GenAI model 210. The user-defined rank 212 may be a numerical value that may determine a level of compression of the GenAI model 210. The model compressing module 202 may then prepare a compressed GenAI model from the GenAI model 210 based on the user-defined rank 212. The compressed GenAI model may include a plurality of compressed weights. It should be noted that a number of the plurality of compressed weights is less than a number of the plurality of weights. In other words, number of parameters of the compressed GenAI model may be fewer than the number of parameters of the GenAI model 210.

The model compressing module 202 may obtain a weight matrix from the plurality of weights of the GenAI model 210. To prepare the compressed GenAI model, the model compressing module 202 may factorize the weight matrix into low rank matrices. In other words, the model compressing module 202 may generate a first low rank weight matrix and a second low rank weight matrix from the weight matrix of the GenAI model 210 based on the user-defined rank 212. The first low rank weight matrix and the second low rank weight matrix may include the plurality of compressed weights. For example, if dimensions of the weight matrix are 4096×4096 and the user-defined rank 212 is ‘2’, then dimensions of the first low rank weight matrix may be 4096×2 and dimensions of the second low rank weight matrix may be 2×4096, such that the weight matrix is a multiplication product of the first low rank weight matrix and the second low rank weight matrix. The total number of weights in the weight matrix is 4096×4096 (i.e., 16,777,216). The total number of weights in each of the first low rank weight matrix and the second low rank weight matrix is 4096×2 (i.e., 8,192). Thus, the number of the plurality of compressed weights (i.e., 8,192+8,192=16,384) is much less than the number of the plurality of weights (i.e., 16,777,216).

Further, the model compressing module 202 may replace the plurality of weights in the GenAI model 210 with the plurality of compressed weights to obtain the compressed GenAI model. Further, the model compressing module 202 may send the GenAI model 210 and the compressed GenAI model to the loss calculating module 204.

Additionally, the loss calculating module 204 may receive a training dataset via a user interface (such as the user interface 110). The input training dataset may include a plurality of training data elements. Each of the plurality of training data elements may be a labeled training data element or an unlabeled training data element. Additionally, for each of the plurality of training data elements, a ground truth output for the training data element may also be provided.

For each of the plurality of training data elements, the loss calculating module 204 may calculate the set of loss values based on the output generated through each of the compressed GenAI model and the GenAI model 210 for the training data element, and the ground truth output for the training data element. In an embodiment, the set of loss values may include a knowledge distillation loss value, a task-specific loss value, and a self-supervised loss value. To calculate the set of loss values, the loss calculating module 204 may input each of the plurality of training data elements to the compressed GenAI model and to the GenAI model 210. Further, the GenAI model 210 and the compressed GenAI model may generate an output for each training data element of the plurality of training data elements.

The knowledge distillation loss value is indicative of performance of the compressed GenAI model in terms of generalized knowledge. To calculate the knowledge distillation loss value, the loss calculating module 204 may compare the output generated through each of the compressed GenAI model and the GenAI model 210 in response to the training data element. Further, the loss calculating module 204 may calculate the knowledge distillation loss value based on the comparing. The task-specific loss value is indicative of performance of the compressed GenAI model in terms of processing task-specific queries. To calculate the task-specific loss value, the loss calculating module 204 may compare the output generated through the compressed GenAI model in response to the training data element and the ground truth output corresponding to the training data element. Further, the loss calculating module 204 may calculate the task-specific loss value based on the comparing. The self-supervised loss value is indicative of self-supervised learning performance of the compressed GenAI model. To calculate the self-supervised loss value, the loss calculating module 204 may calculate, through the compressed GenAI model, the self-supervised loss value based on the training data element and the output generated through the compressed GenAI model in response to the training data element. Upon calculating the set of loss values, the loss calculating module 204 may send the set of loss values to the weight calculating module 206.

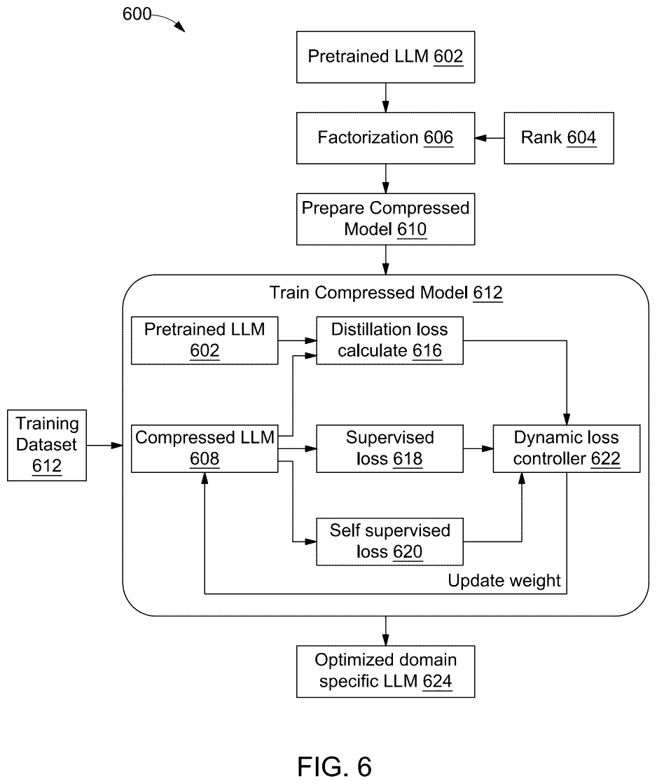

The weight calculating module 206 may dynamically calculate a weight corresponding to each of the set of loss values based on one of the set of loss values. To dynamically calculate the weight corresponding to each of the set of loss values, the weight calculating module 206 may calculate a first weight (a) corresponding to the knowledge distillation loss value based on a previous first weight, a change in the task-specific loss value, and a first hyperparameter. Further, the weight calculating module 206 may calculate a second weight (β) corresponding to the task-specific loss value based on a previous second weight, the change in the task-specific loss value, and a second hyperparameter. Further, the weight calculating module 206 may calculate a third weight (γ) corresponding to the self-supervised loss value based on a previous third weight and the change in the task-specific loss value. This is explained in greater detail in conjunction with FIG. 6.

Further, the weight calculating module 206 may normalize the calculated weight corresponding to each of the set of loss values. Further, the weight calculating module 206 may calculate a weighted loss value for the compressed GenAI model corresponding to the training data element based on the set of loss values and the dynamically calculated weight. The weight calculating module 206 may send the calculated weighted loss value to the fine-tuning module 208. The fine-tuning module 208 may modify the plurality of compressed weights based on the weighted loss value to obtain a fine-tuned compressed GenAI model 214. The fine-tuned compressed GenAI model 214 may be domain-specific and task-specific, and may use less memory storage and computational resources than the GenAI model 210.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for compression and dynamic loss-based training of GenAI models. For example, the exemplary system 100 and the associated computing device 102 may fine-tune the compressed GenAI model by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

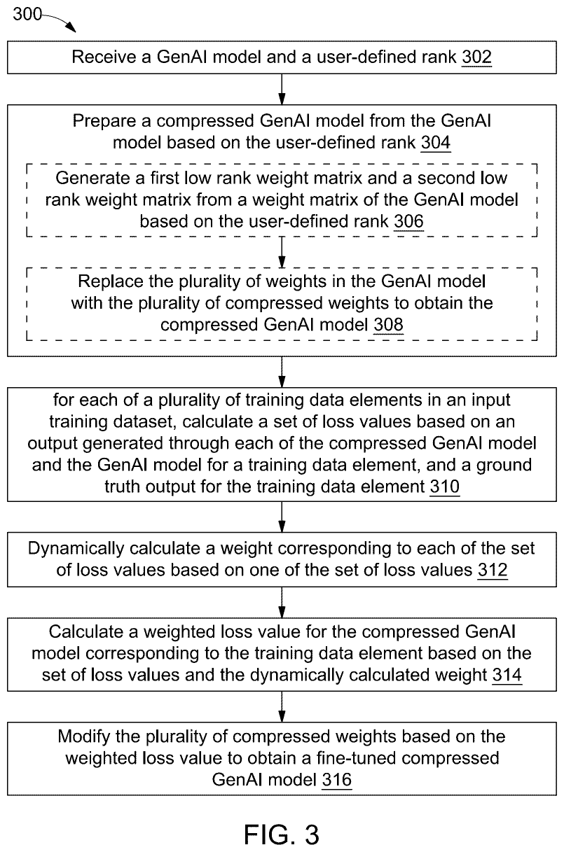

Referring now to FIG. 3, an exemplary process 300 for compression and dynamic loss-based training of GenAI models is depicted via a flowchart, in accordance with some embodiments. FIG. 3 is explained in conjunction with FIGS. 1 and 2. The process 300 may be implemented by the computing device 102 of the system 100. The process 300 may include receiving, by a model compressing module (for example, the model compressing module 202), a GenAI model (for example, the GenAI model 210) and a user-defined rank (for example, the user-defined rank 212), at step 302. The GenAI model may include a plurality of weights.

Further, the process 300 may include preparing, by the model compressing module, a compressed GenAI model from the GenAI model based on the user-defined rank, at step 304. The step 304 may include steps 306 and 308. The compressed GenAI model may include a plurality of compressed weights. A number of the plurality of compressed weights is less than the number of plurality of weights. The process 300 may include generating, by the model compressing module, a first low rank weight matrix and a second low rank weight matrix from a weight matrix of the GenAI model based on the user-defined rank, at step 306. The weight matrix may include the plurality of weights. The first low rank weight matrix and the second low rank weight matrix may include the plurality of compressed weights. Further, the process may include replacing, by the model compressing module, the plurality of weights in the GenAI model with the plurality of compressed weights to obtain the compressed GenAI model, at step 308.

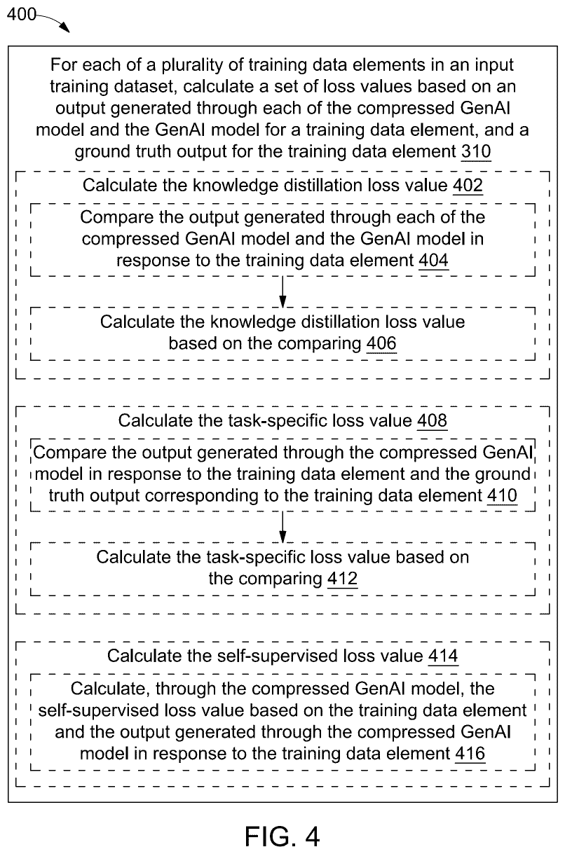

For each of a plurality of training data elements in an input training dataset, the process 300 may include calculating, by a loss calculating module (for example, the loss calculating module 204), a set of loss values based on an output generated through each of the compressed GenAI model and the GenAI model for a training data element, and a ground truth output for the training data element, at step 310. This is explained in greater detail in conjunction with FIGS. 4 and 6. By way of an example, the set of loss values may include, but may not be limited to, a knowledge distillation loss value, a task-specific loss value, and a self-supervised loss value.

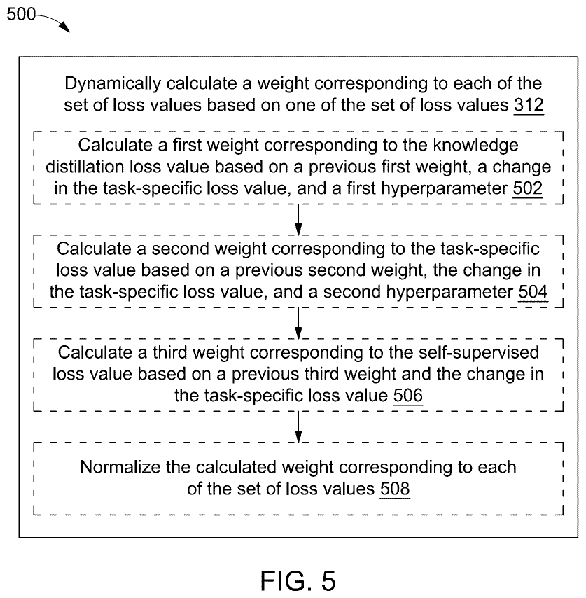

Further, the process 300 may include dynamically calculating, by a weight calculating module (for example, the weight calculating module 206), a weight corresponding to each of the set of loss values based on one of the set of loss values, at step 312. This is explained in greater detail in conjunction with FIGS. 5 and 6. Further, the process 300 may include calculating, by the weight calculating module, a weighted loss value for the compressed GenAI model corresponding to the training data element based on the set of loss values and the dynamically calculated weight, at step 314. Further, the process 300 may include modifying, by a fine-tuning module (for example, the fine-tuning module 208), the plurality of compressed weights based on the weighted loss value to obtain a fine-tuned compressed GenAI model (for example, fine-tuned GenAI model 214), at step 316.

Referring now to FIG. 4, an exemplary process 400 for calculating loss values of compressed GenAI models is depicted via a flowchart, in accordance with some embodiments. FIG. 4 is explained in conjunction with FIGS. 1, 2, and 3. The process 400 may be implemented by the computing device 102 of the system 100. The process 400 may include calculating, by a loss calculating module (for example, the loss calculating module 204), a set of loss values based on an output generated through each of the compressed GenAI model and the GenAI model for a training data element, and a ground truth output for the training data element, at step 310. The step 310 may include the steps 402, 404, 406, 408, 410, 412, 414, and 416. The set of loss values may include a knowledge distillation loss value, a task-specific loss value, and a self-supervised loss value. The process 400 may include calculating, by the loss calculating module, the knowledge distillation loss value, at step 402. The step 402 may include steps 404 and 406. The process 400 may include comparing, by the loss calculating module, the output generated through each of the compressed GenAI model and the GenAI model in response to the training data element, at step 404. Further, the process 400 may include calculating, by the loss calculating module, the knowledge distillation loss value based on the comparing, at step 406.

Thereafter, the process 400 may include calculating, by the loss calculating module, the task-specific loss value, at step 408. The step 408 may include steps 410 and 412. The process 400 may include comparing, by the loss calculating module, the output generated through the compressed GenAI model in response to the training data element and the ground truth output corresponding to the training data element, at step 410. Further, the process 400 may include calculating, by the loss calculating module, the task-specific loss value based on the comparing, at step 412. Thereafter, the process 400 may include calculating, by the loss calculating module, the self-supervised loss value, at step 414. The step 414 may include step 416. The process 400 may include calculating, by the loss calculating module, through the compressed GenAI model, the self-supervised loss value based on the training data element and the output generated through the compressed GenAI model in response to the training data element, at step 416.

Referring now to FIG. 5, an exemplary process 500 for dynamically calculating weights corresponding to loss values of compressed GenAI models is depicted via a flowchart, in accordance with some embodiments. FIG. 5 is explained in conjunction with FIGS. 1-4. The process 500 may be implemented by the computing device 102 of the system 100. The process 500 may include dynamically calculating, by a weight calculating module (for example, the weight calculating module 206), a weight corresponding to each of the set of loss values based on one of the set of loss values, at step 312. The step 312 may include steps 502, 504, 506, and 508. The process 500 may include calculating, by the weight calculating module, a first weight (α) corresponding to the knowledge distillation loss value based on a previous first weight, a change in the task-specific loss value, and a first hyperparameter, at step 502. Further, the process 500 may include calculating, by the weight calculating module, a second weight (β) corresponding to the task-specific loss value based on a previous second weight, the change in the task-specific loss value, and a second hyperparameter, at step 504. Further, the process 500 may include calculating, by the weight calculating module, a third weight (γ) corresponding to the self-supervised loss value based on a previous third weight and the change in the task-specific loss value, at step 506. Further, the process 500 may include normalizing, by the weight calculating module, the calculated weight corresponding to each of the set of loss values, at step 508. This is explained in greater detail in conjunction with FIG. 6.

Referring now to FIG. 6, a detailed exemplary process 600 for compression and dynamic loss-based training of pretrained Large Language Models (LLMs) is depicted via a flowchart, in accordance with an embodiments. FIG. 6 is explained in conjunction with FIGS. 1-5. The process 600 may be implemented by the computing device 102 of the system 100. The process 600 may include receiving, by the model compressing module 202, a pretrained LLM 602 and a rank 604 from a user. The pretrained LLM 602 may be analogous to the GenAI model 210 and the rank 604 may be analogous to the user-defined rank 212. The pretrained LLM 602 may include a plurality of linear layers. Each of the plurality of linear layers may include input features and output features. A plurality of weights may be associated with each of the plurality of linear layers (i.e., a weight associated with each pair of an input feature and an output feature).

Further, the model compressing module 202 may obtain a weight matrix for each of the plurality of linear layers of the pretrained LLM 602 based on the plurality of weights. In an embodiment, for a weight matrix of a linear layer, the rows may correspond to the input features of the linear layer and the columns may correspond to the output features of the linear layer. Additionally, each element of the weight matrix may be a weight associated with a corresponding input feature and output feature. Further, the process 600 may include performing factorization of the weight matrix, at step 606. The factorization may include generating, by the model compressing module 202, a first low rank matrix and a second low rank matrix from the weight matrix of the pretrained LLM 602 based on the rank 604. Dimensions of each of the first low rank matrix and the second low rank matrix may be less than the dimensions of the weight matrix. It should be noted that the first low rank weight matrix and the second low rank weight matrix may include the plurality of compressed weights.

By way of an example, the pretrained LLM 602 may be a Llama model. The Llama model may include a plurality of layers. One of the plurality of layers may be an attention layer including 4 linear projection layers—‘q_proj’, ‘k_proj’, ‘v_proj’, and ‘o_proj’. Each of the 4 linear projection layers may include 4096 input features and 4096 output features. Thus, for each of the 4 linear layers, a weight matrix of the dimensions 4096×4096 may be obtained. Further, for the rank 604 of ‘8’, the model compressing module 202 may perform factorization of the weight matrix to generate a first low rank weight matrix of dimensions 4096×8 (i.e., 4096 rows and 8 columns) and a second low rank weight matrix of dimensions 8×4096 (i.e., 8 rows and 4096 columns).

Further, the process 600 may include preparing, by the model compressing module 202, a compressed LLM 608 by replacing the plurality of weights in the pretrained LLM 602 with the plurality of compressed weights, at step 610. Further, the process 600 may include training, by the fine-tuning module 208, the compressed LLM 608, at step 612. To train the compressed LLM, the process 600 may include inputting, by the model compressing module 202, training data 614 to each of the compressed LLM 608 and the pretrained LLM 602. Further, the pretrained LLM 602 and the compressed LLM 608 may generate an output in response to the training data 614.

Further, the process 600 may include calculating, by the loss calculating module 204, a distillation loss value 616 (i.e., knowledge distillation loss value, L_{distillation}), a supervised loss value 618 (i.e., task-specific loss value Lₜₐₛₖ), and a self-supervised loss value 620 (L_{self}). To calculate the distillation loss value 616, the process 600 may include comparing, by the loss calculating module 204, the output generated through each of the compressed LLM 608 and the pretrained LLM 602. Further, the process 600 may include calculating, by the loss calculating module 204, the distillation loss value 616 based on the comparing.

To calculate the supervised loss value 618, the process 600 may include comparing, by the loss calculating module 204, the output generated through the compressed LLM 608 in response to the training data 614 and the ground truth output corresponding to the training data 614. Further, the process 600 may include calculating, by the loss calculating module 204, the supervised loss value 618 based on the comparing. The process 600 may include calculating, by the loss calculating module 204, the self-supervised loss value 620 based on the training data 614 and the output generated through the compressed LLM 608 in response to the training data 614. The loss calculating module 204 may then send each of the distillation loss value 616, the supervised loss value 618, and the self-supervised loss value 620 to a dynamic loss controller 622. In an embodiment, the dynamic loss controller 622 may be analogous to the weight calculating module 206. The dynamic loss controller 622 may dynamically calculate a weight corresponding to each of the distillation loss value 616, the supervised loss value 618, and the self-supervised loss value 620.

To dynamically calculate the weight, the process 600 may include calculating, by the dynamic loss controller 622, a first weight (α_{new}) corresponding to the distillation loss value 616 based on a previous first weight (α_{old}), a change in the supervised loss value 618 (ΔLₜₐₛₖ), and a first hyperparameter (k). The first hyperparameter may be a decay factor of the first weight. A larger value of k may denote rapid reduction in the first weight and a smaller value of k may denote slower transition. The first weight may be calculated through equation (1).

$${α}_{new} = {α}_{old} \times exp ( k \times Δ {L}_{task} ) \qquad ( 1 )$$

The dynamic loss controller 622 may increase the first weight if the supervised loss value 618 worsens during training cycle. The dynamic loss controller 622 may decrease the first weight if the supervised loss value 618 improves during the training cycle.

Further, the process 600 may include calculating, by the dynamic loss controller 622, a second weight (β_{new}) corresponding to the supervised loss value 618 based on a previous second weight (β_{old}), the change in the supervised loss value 618, and a second hyperparameter (η). The second hyperparameter corresponds to a step size of β. A larger value of η may denote a faster focus shift to task-specific learning. A smaller value of η may denote a more gradual transition to task-specific learning. The second weight may be calculated through equation (2).

$${β}_{new} = {β}_{old} - η \times Δ {L}_{task} \qquad ( 2 )$$

Further, the process 600 may include calculating, by the dynamic loss controller 622, a third weight (γ_{new}) corresponding to the self-supervised loss value 620 based on a previous third weight (γ_{old}), and the change in the supervised loss value 618. The third weight may be calculated through equation (3).

$${γ}_{new} = {γ}_{old} \times ( 1 + δ ) \qquad ( 3 )$$

It should be noted that 5 is a factor that may determine adjustment levels required in the third weight based on the supervised loss value 618. If ΔLₜₐₛₖ>0 (i.e., the supervised loss value 618 is increasing and the compressed LLM 608 is performing worse), the third weight may be increased to focus more on self-supervised learning. If ΔLₜₐₛₖ<0 (i.e., the supervised loss values is decreasing and performance of the compressed LLM 608 is improving), the third weight may be decreased to let the compressed LLM 608 rely more on task-specific training. In an embodiment, the magnitude of 5 may scale the change in the third weight based on magnitude of the ΔLₜₐₛₖ and integer sign of the ΔLₜₐₛₖ (i.e., whether ΔLₜₐₛₖ is a positive value or negative value). The δ may be calculated through equation (4).

$$δ = sign ( Δ {L}_{task} ) \times \vert \frac{Δ {L}_{task}}{\vert {L}_{old} \vert + ϵ} \vert \qquad ( 4 )$$

where ϵ is a small constant value to avoid division by zero.

Thus, each of the set of loss values may be dynamically updated during the training cycle based on a change in the supervised loss value 618 and hyperparameters. Based on the set of loss values and the associated weights, a weighted total loss value is calculated through equation (5). The overall goal of the training process is to minimize the weighted total loss, whereas the associated weights prioritize or de-prioritize a particular type of training of the compressed LLM 608.

$${L}_{total} = α . {L}_{distillation} + β . {L}_{task} + γ . {L}_{self} \qquad ( 5 )$$

Further, the process 600 may include normalizing, by the dynamic loss controller 622, each of the first weight, the second weight, and the third weight. The normalizing ensures that a sum of the first weight, the second weight, and the third weight is equal to 1. The normalizing also ensures that components (i.e., the set of loss values) are balanced in terms of contribution of the total loss, regardless of change in individual values of the components. Additionally, the normalizing prevents domination or bias towards one particular type of training. Any single weight may be prevented from growing too large and from dominating the total loss. Additionally, the normalizing may enable adapting of the weights dynamically to maintain a sum of 1.

By way of an example, initial values of the weights may be α_{old}=0.5, β_{old}=0.3, and γ_{old}=0.2. Additionally, ΔLₜₐₛₖ=−0.05 (indicating a decreasing supervised loss value 618), k=2.5, η=0.1, and L_{old}=0.6, ε=10⁻⁶.

The dynamic loss controller 622 may calculate anew through the equation (1) as described below.

$${α}_{new} = {α}_{old} \times exp ( k \times Δ {L}_{task} )$$

$${α}_{new} = 0.5 \times exp ( 2.5 \times ( - 0.05 ) )$$

$${α}_{new} = 0.5 \times exp ( - 0.125 ) = 0.4413$$

The dynamic loss controller 622 may calculate β_{new} through the equation (2) as described below:

$${β}_{new} = {β}_{old} - η \times Δ {L}_{task}$$

$${β}_{new} = 0.3 - ( 0.1 \times - 0.05 )$$

$${β}_{new} = 0.3 + 0.005 = 0 \text{.305}$$

$$Note : Since Δ {L}_{task} is negative , {β}_{new} increases .$$

The dynamic loss controller 622 may calculate γ_{new} through the equations (3) and (4) as described below:

$$δ = sign ( Δ {L}_{task} ) \times \vert \frac{Δ {L}_{task}}{\vert {L}_{old} \vert + ϵ} \vert$$

$$δ = sign ( - 0.05 ) \times \vert \frac{- 0.05}{\vert 0.6 \vert + {10}^{- 6}} \vert$$

$$δ = - 1 \times \vert \frac{- 0.05}{0.600001} \vert = - 0.0833$$

$$Now , {γ}_{new} = {γ}_{old} \times ( 1 + δ )$$

$${γ}_{new} = 0.2 \times ( 1 - 0.0833 ) = 0.1833$$

Further, the dynamic loss controller 622 may normalize α_{new}, β_{new}, and γ_{new}. First, the dynamic loss controller 622 may calculate a sum of the new weight values, S.

$$S = {α}_{new} + {β}_{new} + {γ}_{new}$$

$$S = 0. 4413 + 0.305 + 0.1833 = 0.9296$$

Further, the dynamic loss controller 622 may normalize each of the α_{new}, β_{new}, and γ_{new}. The normalized values αₙₒᵣₘ, βₙₒᵣₘ, and γₙₒᵣₘ may be calculated as described below.

$${α}_{norm} = \frac{{α}_{new}}{s} = \frac{0.4413}{0.9296} = 0 \text{.4749}$$

$${β}_{norm} = \frac{β new}{s} = \frac{0.305}{0.9296} = 0.3282$$

$${γ}_{norm} = \frac{γ new}{s} = \frac{0.1833}{0.9296} = 0.1971$$

Once normalization is done, the process 600 may include calculating, by the dynamic loss controller 622, a total loss through the equation (5). Further, the process 600 may include modifying (or updating), by the fine-tuning module 208, the plurality of compressed weights based on the weighted loss value to obtain an optimized domain specific LLM 624. The optimized domain specific LLM 624 may be analogous to the fine-tuned compressed GenAI model 214.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

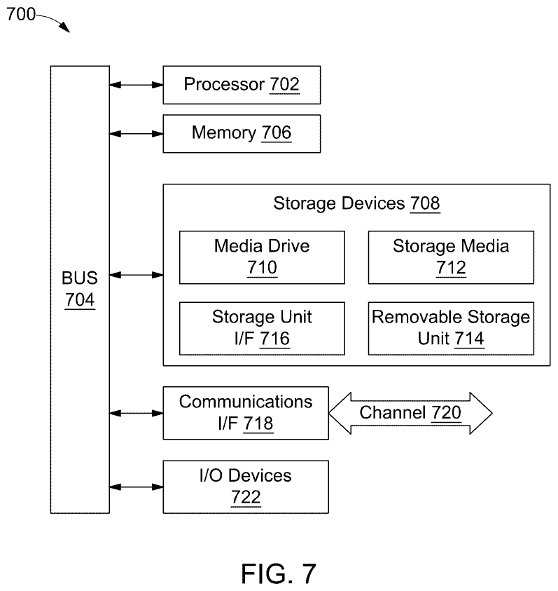

The disclosed methods and systems may be implemented on a conventional or a general-purpose computer system, such as a personal computer (PC) or server computer. Referring now to FIG. 7, an exemplary computing system 700 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 700 may represent, for example, a user device such as a desktop, a laptop, a mobile phone, personal entertainment device, DVR, and so on, or any other type of special or general-purpose computing device as may be desirable or appropriate for a given application or environment. The computing system 700 may include one or more processors, such as a processor 702 that may be implemented using a general or special purpose processing engine such as, for example, a microprocessor, microcontroller or other control logic. In this example, the processor 702 is connected to a bus 704 or other communication medium. In some embodiments, the processor 702 may be an Artificial Intelligence (AI) processor, which may be implemented as a Tensor Processing Unit (TPU), or a graphical processor unit, or a custom programmable solution Field-Programmable Gate Array (FPGA).

The computing system 700 may also include a memory 706 (main memory), for example, Random Access Memory (RAM) or other dynamic memory, for storing information and instructions to be executed by the processor 702. The memory 706 also may be used for storing temporary variables or other intermediate information during execution of instructions to be executed by the processor 702. The computing system 700 may likewise include a read only memory (“ROM”) or other static storage device coupled to bus 704 for storing static information and instructions for the processor 702.

The computing system 700 may also include a storage devices 708, which may include, for example, a media drive 710 and a removable storage interface. The media drive 710 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 712 may include, for example, a hard disk, magnetic tape, flash drive, or other fixed or removable medium that is read by and written to by the media drive 710. As these examples illustrate, the storage media 712 may include a computer-readable storage medium having stored therein particular computer software or data.

In alternative embodiments, the storage devices 708 may include other similar instrumentalities for allowing computer programs or other instructions or data to be loaded into the computing system 700. Such instrumentalities may include, for example, a removable storage unit 714 and a storage unit interface 716, such as a program cartridge and cartridge interface, a removable memory (for example, a flash memory or other removable memory module) and memory slot, and other removable storage units and interfaces that allow software and data to be transferred from the removable storage unit 714 to the computing system 700.

The computing system 700 may also include a communications interface 718. The communications interface 718 may be used to allow software and data to be transferred between the computing system 700 and external devices. Examples of the communications interface 718 may include a network interface (such as an Ethernet or other NIC card), a communications port (such as for example, a USB port, a micro USB port), Near field Communication (NFC), etc. Software and data transferred via the communications interface 718 are in the form of signals which may be electronic, electromagnetic, optical, or other signals capable of being received by the communications interface 718. These signals are provided to the communications interface 718 via a channel 720. The channel 720 may carry signals and may be implemented using a wireless medium, wire or cable, fiber optics, or other communications medium. Some examples of the channel 720 may include a phone line, a cellular phone link, an RF link, a Bluetooth link, a network interface, a local or wide area network, and other communications channels.

The computing system 700 may further include Input/Output (I/O) devices 722. Examples may include, but are not limited to a display, keypad, microphone, audio speakers, vibrating motor, LED lights, etc. The I/O devices 722 may receive input from a user and also display an output of the computation performed by the processor 702. In this document, the terms “computer program product” and “computer-readable medium” may be used generally to refer to media such as, for example, the memory 706, the storage devices 708, the removable storage unit 714, or signal(s) on the channel 720. These and other forms of computer-readable media may be involved in providing one or more sequences of one or more instructions to the processor 702 for execution. Such instructions, generally referred to as “computer program code” (which may be grouped in the form of computer programs or other groupings), when executed, enable the computing system 700 to perform features or functions of embodiments of the present invention.

In an embodiment where the elements are implemented using software, the software may be stored in a computer-readable medium and loaded into the computing system 700 using, for example, the removable storage unit 714, the media drive 710 or the communications interface 718. The control logic (in this example, software instructions or computer program code), when executed by the processor 702, causes the processor 702 to perform the functions of the invention as described herein.

Thus, the disclosed method and system try to overcome the technical problem of compression and dynamic loss-based training of GenAI models. The disclosed method and system may receive a GenAI model and a user-defined rank. The GenAI model may include a plurality of weights. The disclosed method and system may further prepare a compressed GenAI model from the GenAI model based on the user-defined rank. The compressed GenAI model may include a plurality of compressed weights. A number of the plurality of compressed weights is less than a number of the plurality of weights. Further, for each of a plurality of training data elements in an input training dataset, the disclosed method and system may calculate a set of loss values based on an output generated through each of the compressed GenAI model and the GenAI model for a training data element, and a ground truth output for the training data element. Further, the disclosed method and system may dynamically calculate a weight corresponding to each of the set of loss values based on one of the set of loss values. Further, the disclosed method and system may calculate a weighted loss value for the compressed GenAI model corresponding to the training data element based on the set of loss values and the dynamically calculated weight. Further, the disclosed method and system may include modifying the plurality of compressed weights based on the weighted loss value to obtain a fine-tuned compressed GenAI model.

As will be appreciated by those skilled in the art, the techniques described in the various embodiments discussed above are not routine, or conventional, or well understood in the art. The techniques may include reducing dependency on a teacher model (i.e., the pretrained GenAI model) and may emphasize task-specific learning. The teacher model may be already compressed and suboptimal for domain-specific tasks. By gradually shifting the focus from distillation to the task specific self-supervised learning, the student model (i.e., the compressed GenAI model) may surpass performance of the teacher model. The techniques may allow the GenAI model to generalize better to domain-specific data rather than inheriting constraints of the teacher model. The techniques may further include adapting the training strategy, and ensuring a balanced and efficient learning process. The techniques may include extracting useful information in early training process. As the training progresses, the techniques may include gradually focusing on domain-specific patterns. The techniques may include dynamically adjusting the schedule for the distillation loss value, the task-specific value, and the self-supervised losses. The techniques may include continuous monitoring of the current loss contributions. The continuous monitoring may ensure faster domain-specific convergence. The techniques may include intelligently adjusting the weights of each of the set of loss values in real-time, prioritizing the set of loss values that may be most effective at driving learning process of the model.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for compression and dynamic loss-based training of GenAI models. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for compression and dynamic loss-based training of Generative Artificial Intelligence (GenAI) models, the method comprising:
receiving, by a computing device, a GenAI model and a user-defined rank, wherein the GenAI model comprises a plurality of weights;
preparing, by the computing device, a compressed GenAI model from the GenAI model based on the user-defined rank, wherein the compressed GenAI model comprises a plurality of compressed weights, and wherein a number of the plurality of compressed weights is less than a number of the plurality of weights;
for each of a plurality of training data elements in an input training dataset, calculating, by the computing device, a set of loss values based on an output generated through each of the compressed GenAI model and the GenAI model for a training data element, and a ground truth output for the training data element;
dynamically calculating, by the computing device, a weight corresponding to each of the set of loss values based on one of the set of loss values;
calculating, by the computing device, a weighted loss value for the compressed GenAI model corresponding to the training data element based on the set of loss values and the dynamically calculated weight; and
modifying, by the computing device, the plurality of compressed weights based on the weighted loss value to obtain a fine-tuned compressed GenAI model.

2. The method of claim 1, wherein preparing the compressed GenAI model comprises:
generating a first low rank weight matrix and a second low rank weight matrix from a weight matrix of the GenAI model based on the user-defined rank, wherein the weight matrix comprises the plurality of weights, and wherein the first low rank weight matrix and the second low rank weight matrix comprise the plurality of compressed weights; and
replacing the plurality of weights in the GenAI model with the plurality of compressed weights to obtain the compressed GenAI model.

3. The method of claim 1, wherein the set of loss values comprises a knowledge distillation loss value, a task-specific loss value, and a self-supervised loss value.

4. The method of claim 3, wherein calculating the knowledge distillation loss value comprises:
comparing the output generated through each of the compressed GenAI model and the GenAI model in response to the training data element; and
calculating the knowledge distillation loss value based on the comparing.

5. The method of claim 3, wherein calculating the task-specific loss value comprises:
comparing the output generated through the compressed GenAI model in response to the training data element and the ground truth output corresponding to the training data element; and
calculating the task-specific loss value based on the comparing.

6. The method of claim 3, wherein calculating the self-supervised loss value comprises calculating, through the compressed GenAI model, the self-supervised loss value based on the training data element and the output generated through the compressed GenAI model in response to the training data element.

7. The method of claim 3, wherein dynamically calculating the weight corresponding to each of the set of loss values comprises:
calculating a first weight corresponding to the knowledge distillation loss value based on a previous first weight, a change in the task-specific loss value, and a first hyperparameter;
calculating a second weight corresponding to the task-specific loss value based on a previous second weight, the change in the task-specific loss value, and a second hyperparameter;
calculating a third weight corresponding to the self-supervised loss value based on a previous third weight and the change in the task-specific loss value; and
normalizing the calculated weight corresponding to each of the set of loss values.

8. A system for compression and dynamic loss-based training of Generative Artificial Intelligence (GenAI) models, the system comprising:
a processor; and
a memory communicatively coupled to the processor, wherein the memory stores processor instructions, which when executed by the processor, cause the processor to:
receive a GenAI model and a user-defined rank, wherein the GenAI model comprises a plurality of weights;
prepare a compressed GenAI model from the GenAI model based on the user-defined rank, wherein the compressed GenAI model comprises a plurality of compressed weights, and wherein a number of the plurality of compressed weights is less than a number of the plurality of weights;
for each of a plurality of training data elements in an input training dataset, calculate a set of loss values based on an output generated through each of the compressed GenAI model and the GenAI model for a training data element, and a ground truth output for the training data element;
dynamically calculate a weight corresponding to each of the set of loss values based on one of the set of loss values;
calculate a weighted loss value for the compressed GenAI model corresponding to the training data element based on the set of loss values and the dynamically calculated weight; and
modify the plurality of compressed weights based on the weighted loss value to obtain a fine-tuned compressed GenAI model.

9. The system of claim 8, wherein to prepare the compressed GenAI model, the processor instructions, on execution, cause the processor to:
generate a first low rank weight matrix and a second low rank weight matrix from a weight matrix of the GenAI model based on the user-defined rank, wherein the weight matrix comprises the plurality of weights, and wherein the first low rank weight matrix and the second low rank weight matrix comprise the plurality of compressed weights; and
replace the plurality of weights in the GenAI model with the plurality of compressed weights to obtain the compressed GenAI model.

10. The system of claim 8, wherein the set of loss values comprises a knowledge distillation loss value, a task-specific loss value, and a self-supervised loss value.
